(19) United States
(12) Patent Application Publication
(10) Pub. No.: US 2026/0086478 A1
(43) Pub. Date: Mar. 26, 2026

(54) DEVELOPING DEVICE

(71) Applicant: CANON KABUSHIKI KAISHA, Tokyo (JP)

(72) Inventor: Chihiro Tanaka, Chiba (JP)

(21) Appl. No.: 19/321,467

(22) Filed: Sep. 8, 2025

(30) Foreign Application Priority Data
Sep. 24, 2024 (JP) 2024-165044
Aug. 22, 2025 (JP) 2025-139265

(51) Int. Cl. G03G 15/09; G03G 15/08

(52) U.S. Cl. CPC G03G 15/0942; G03G 15/0812; G03G 15/0891; G03G 2215/0609

(57) ABSTRACT

A developing device includes a first rotatable member, a second rotatable member, a first feeding screw, a second feeding screw, and a guiding portion. In a case where a normal component of magnetic flux density of the second rotatable member is Br, a tangential component of the magnetic flux density is Bθ, and an angle Θ of a magnetic brush is arctan (Br/Bθ), there is a portion where the angle Θ of the magnetic brush is 45° or more in a range from an intersection point where a rectilinear line passing through an end portion of the guiding portion and a rotation center of the second rotatable member crosses an outer peripheral surface of the second rotatable member, to a closest point where the outer peripheral surface of the second rotatable member is closest to the guiding portion.

### BACKGROUND

### Field of the Technology

The present disclosure relates to a developing device for developing an electrostatic latent image, with a developer, formed on an image bearing member.

### Description of the Related Art

As the developing device using a two-component developer including toner and a magnetic carrier, a constitution in which a magnet having a plurality of magnetic poles inside a developing roller and in which the developer is carried on the developing roller and develops the electrostatic latent image formed on the image bearing member is employed in general.

Further, a constitution in which the developer peeled off from a peeling roller provided opposed to the developing roller on a side of the developing roller is collected and delivered to a developer circulating portion for circulating the developer is proposed (U.S. Patent Publication No. US2013/0330107). In the developing device disclosed in US2013/0330107, below the peeling roller in a vertical direction, a guiding portion for guiding the developer, peeled off from the peeling roller, toward a feeding screw for embodiment the developer to the developer circulating portion is provided.

In the case of the constitution disclosed in US2013/0330107, in a delivering step of the developer from the developing roller to the peeling roller, there is a liability that toner scattering due to falling of a magnetic brush (chain) between magnetic poles during feeding in which the peeling roller feeds, to a peeling position, the developer received from the developing roller and toner scattering due to detachment of the toner during peeling-off are caused to occur. As regards these scattered toner, by the influence of air flow generated between the developing roller and the peeling roller, a part of the toner scattered while being carried by the air flow is deposited on the guiding portion immediately below the developing peeling roller.

When the toner deposited on the guiding portion drops into a periphery of the developing roller or the developer circulating portion, the dropped toner is mixed in a normal developer, and therefore, unevenness of a toner amount of the toner moved to a photosensitive drum when the electrostatic latent image is developed into a toner image on the photosensitive drum occurs, so that there is a liability that unevenness in density occurs also on a final output image.

### SUMMARY

An aspect of the present disclosure is directed to suppress an occurrence of an image defect.

According to another aspect of the present disclosure, there is provided a developing device comprising: a first chamber configured to accommodate a developer including toner and a carrier; a first feeding screw provided in the first chamber and configured to feed the developer accommodated in the first chamber; a second chamber partitioned from the first chamber by a partition wall; a second feeding screw provided in the second chamber and configured to feed the developer accommodated in the second chamber; a first rotatable developing member to which the developer is supplied, the first rotatable developing member carrying and feeding the developer to a developing position where an electrostatic latent image formed on an image bearing member is developed; a first magnet provided non-rotatably and stationarily inside the first rotatable developing member, the first magnet including a first magnetic pole provided opposed to the image bearing member in the developing position, a second magnetic pole provided downstream of the first magnetic pole with respect to a rotational direction of the first rotatable developing member, and a third magnetic pole provided downstream of the second magnetic pole and adjacent to the second magnetic pole, with respect to the rotational direction of the first rotatable developing member, and having the same magnetic polarity as that of the second magnetic pole; a second rotatable member provided opposed to the first rotatable developing member and to which the developer is delivered from the first rotatable developing member by a magnetic field generated by the first magnet, the second rotatable member carrying and feeding the developer for collecting, in the second chamber, the developer after the electrostatic latent image is developed; a second magnet provided non-rotatably and stationarily inside the second rotatable developing member, the second magnet including a fourth magnetic pole having a magnetic polarity different from that of the second magnetic pole, a fifth magnetic pole provided downstream of the fourth magnetic pole with respect to a rotational direction of the second rotatable member, a sixth magnetic pole provided downstream of the fifth magnetic pole and adjacent to the fifth magnetic pole, with respect to the rotational direction of the second rotatable member, and having a magnetic polarity different from that of the fifth magnetic pole, and a seventh magnetic pole provided downstream of the sixth magnetic pole and adjacent to the sixth magnetic pole, with respect to the rotational direction of the second rotatable member, and having the same magnetic polarity as that of the sixth magnetic pole; and a guiding portion provided opposed to the second rotatable member and configured to guide the developer to the second feeding screw, wherein the first rotatable developing member and the second rotatable member rotate in the same direction in mutually opposing positions thereof, wherein the developer after the electrostatic latent image is developed is delivered from the first rotatable developing member to the second rotatable member by a magnetic field generated between the second magnetic pole and the fourth magnetic pole; and wherein in a case where a normal component of magnetic flux density in an arbitrary point on an outer peripheral surface of the second rotatable member opposing an inclined surface of the guiding portion is Br, a tangential component of the magnetic flux density in the arbitrary point is θ, and an angle Θ of a magnetic brush in the arbitrary point is arctan (Br/Bθ), with respect to the rotational direction of the second rotatable member, there is a portion where an absolute value of the angle Θ of the magnetic brush is 45° or more in a range from an intersection point, on the outer peripheral surface of the second rotatable member, which is a point where a rectilinear line passing through an end portion of the guiding portion on a side opposite from the second feeding screw and a rotation center of the second rotatable member crosses the outer peripheral surface of the second rotatable member, to a closest point, on the outer peripheral surface of the second rotatable member, which is a point where the outer peripheral surface of the second rotatable member is closest to the guiding portion.

Features of the present disclosure will become apparent from the following description of embodiments with reference to the attached drawings.

The following description of embodiments are described by way of example.

### BRIEF DESCRIPTION OF THE DRAWINGS

FIG. 1 is a schematic structural sectional view of an image forming apparatus according to an embodiment.

FIG. 2 is a schematic structural sectional view of a developing device according to the embodiment.

FIG. 3 is a schematic view showing a magnetic pole arrangement of a first developing roller in the embodiment.

FIG. 4 is a schematic view showing a magnetic pole arrangement of a second developing roller in the embodiment.

FIG. 5 is a schematic view showing a magnetic pole arrangement of a peeling roller in the embodiment.

FIG. 6 is a schematic view showing an arrangement relationship between the second developing roller, the peeling roller, and a guiding member in the embodiment.

Part (a) of FIG. 7 is a schematic view in the case where an angle of a magnetic brush (chain) becomes negative, and part (b) of FIG. 7 is a schematic view in the case where the angle of the magnetic brush becomes positive.

Part (a) of FIG. 8 is a graph showing distributions of a normal component and a tangential component of magnetic flux density on a peeling sleeve of a third magnet in a comparison example 1, and part (b) of FIG. 8 is a graph showing an angle of a magnetic brush on the peeling sleeve of the third magnet in the comparison example 1.

Part (a) of FIG. 9 is a graph showing distributions of a normal component and a tangential component of magnetic flux density on a peeling sleeve of a third magnet in an embodiment 1, and part (b) of FIG. 9 is a graph showing an angle of a magnetic brush on the peeling sleeve of the third magnet in the embodiment 1.

Part (a) of FIG. 10 is a graph showing distribution of a normal component and a tangential component of magnetic flux density on a peeling sleeve of a third magnet in an embodiment 2, and part (b) of FIG. 10 is a graph showing an angle of a magnetic brush on the peeling sleeve of the third magnet in the embodiment 2.

Part (a) of FIG. 11 is a graph showing distributions of a normal component and a tangential component of magnetic flux density on a peeling sleeve of a third magnet in an embodiment 3, and part (b) of FIG. 11 is a graph showing an angle of a magnetic brush on the peeling sleeve of the third magnet in the embodiment 3.

Part (a) of FIG. 12 is a graph showing distribution of a normal component and a tangential component of magnetic flux density on a peeling sleeve of a third magnet in an embodiment 4, and part (b) of FIG. 12 is a graph showing an angle of a magnetic brush on the peeling sleeve of the third magnet in the embodiment 4.

### DESCRIPTION OF THE EMBODIMENTS

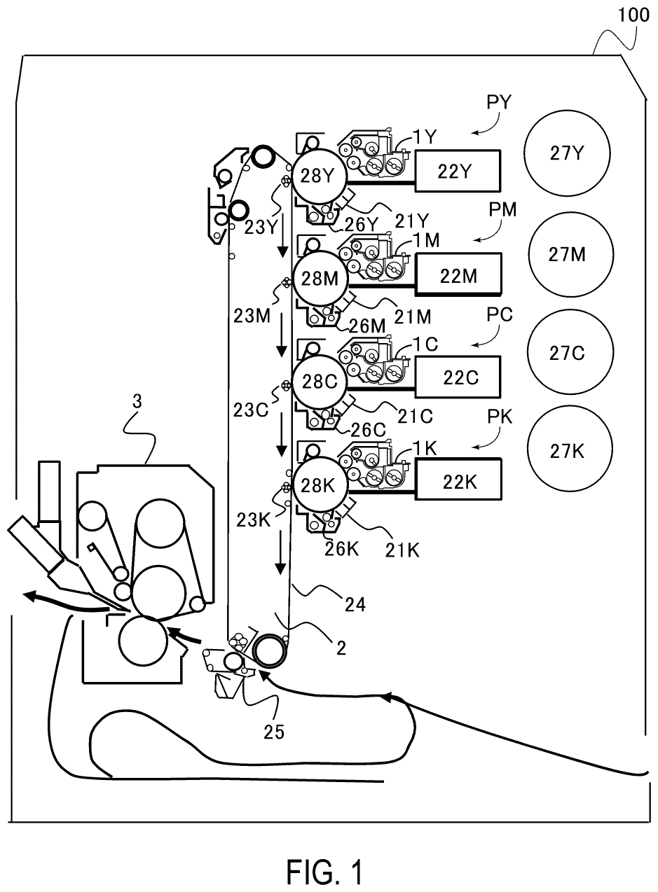

An embodiment will be described using FIG. 1 to part (b) of FIG. 12. First, a general structure of an image forming apparatus in the embodiment will be described with reference to FIG. 1.

### [Image Forming Apparatus]

An image forming apparatus 100 is a full-color image forming apparatus, and in the case of this embodiment, the image forming apparatus 100 is, for example, an MFP (multi-function peripheral) having a copy function, a printer function, and a scan function. The image forming apparatus 100 includes, as shown in FIG. 1, image forming portions PY, PM, PC, and PK for performing an image forming step of forming toner images of four colors of yellow, magenta, cyan, and black, respectively, which are juxtaposed.

The image forming portions PY, PM, PC, and PK for the respective colors include primary chargers 21Y, 21M, 21C, and 21K, developing devices 1Y, 1M, 1C, and 1K, optical write portions (exposure devices) 22Y, 22M, 22C, and 22K, photosensitive drums 28Y, 28M, 28C, and 28K, and cleaning devices 26Y, 26M, 26C, and 26K, respectively. Further, the image forming apparatus 100 includes a transfer device 2 and a fixing device 3. Incidentally, structures of the image forming portions PY, PM, PC, and PK are similar to each other, and therefore, in the following, description will be described using the image forming portion PY as a representative.

The photosensitive drum 28Y as an image bearing member is a photosensitive member, having a photosensitive layer formed of a resin such as polycarbonate, containing an organic photoconductor (OPC), and is constituted so as to be rotated at a predetermined speed. In this embodiment, a line speed of the photosensitive drum 28Y is set to 650 mm/s. The primary charger 21Y includes a corona discharge electrode disposed at a periphery of the photosensitive drum 28Y and electrically charges a surface of the photosensitive drum 28Y by generated ions.

In the optical write portion 22Y, a scanning optical device is assembled, and by exposing the charged photosensitive drum 28Y to light on the basis of image data, a potential of an exposed portion is lowered, so that a charge pattern (electrostatic latent image) corresponding to the image data is formed. The developing device 1Y develops the electrostatic latent image, formed on the photosensitive drum 28Y, by transferring a developer accommodated therein onto the photosensitive drum 28Y. The developer is prepared by mixing a carrier with toner of an associated color, and the electrostatic latent image is visualized (developed) by the toner.

The transfer device 2 includes primary transfer rollers 23Y, 23M, 23C, and 23K, an intermediary transfer belt 24, and a secondary transfer roller 25. The intermediary transfer belt 24 is wound around the primary transfer rollers 23Y, 23M, 23C, and 23K and a plurality of rollers, and is supported so as to be travelable.

The primary transfer rollers 23Y, 23M, 23C, and 23K are disposed in a named order from above in FIG. 1 and correspond to the colors of Y (yellow), M (magenta), C (cyan), and K (black), respectively. The secondary transfer roller 25 is disposed outside the intermediary transfer belt 24 and is constituted so that a recording material is capable of passing through between the secondary transfer roller 25 and the intermediary transfer belt 24. Incidentally, the recording material is a sheet such as paper or a plastic sheet.

The toner images of the respective colors formed on the photosensitive drums 28Y, 28M, 28C, and 28K are successively transferred onto the intermediary transfer belt 24 by the primary transfer rollers 23Y, 23M, 23C, and 23K, respectively, so that a color toner image including superimposed layers of the colors of yellow, magenta, cyan, and black. The thus-formed toner image is transferred by the secondary transfer roller 25 onto the recording material fed from a cassette or the like in which recording materials are accommodated. The recording material on which the toner image is transferred is pressed and heated in the fixing device 3. By this, the toner on the recording material is melted, so that the color image is fixed on the recording material.

Developer storage portions 27Y, 27M, 27C, and 27K are provided corresponding to the developing devices 1Y, 1M, 1C, and 1K, respectively, and in which bottles accommodating developers corresponding to the colors of yellow, magenta, cyan, and black are exchangeably mounted in a named order from above, respectively. The developer storage portions 27Y, 27M, 27C, and 27K are constituted so that the developers are capable of being fed (supplied) therefrom to the developing devices 1Y, 1M, 1C, and 1K corresponding to the colors of the developers stored therein, respectively.

For example, a toner weight ratio of the developer accommodated in each bottle is 80 to 95%, and a toner weight ratio of the developer in each of the developing devices 1Y, 1M, 1C, and 1K is 5 to 10%. For that reason, when the toner is consumed by development in each of the developing devices 1Y, 1M, 1C, and 1K, the developer containing the toner in an amount corresponding to a consumption amount of the toner is supplied, so that the toner weight ratio of the developer in each of the developing devices 1Y, 1M, 1C, and 1K is maintained in a constant amount.

### [Developing Device]

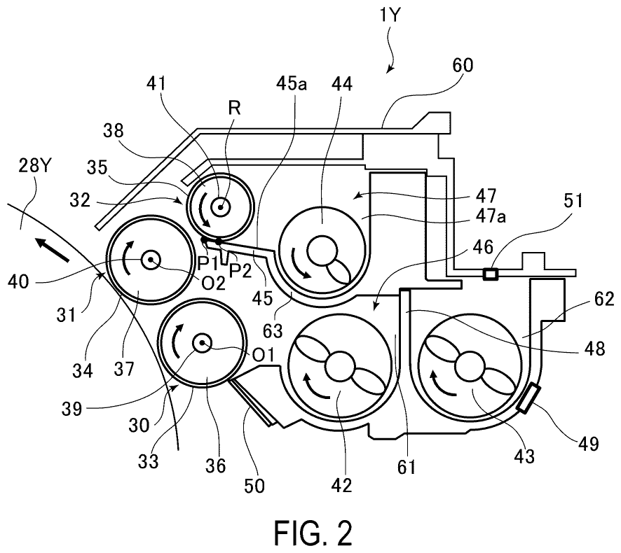

Next, the photosensitive drums 1Y, 1M, 1C, and 1K will be specifically described using FIGS. 2 to 5.

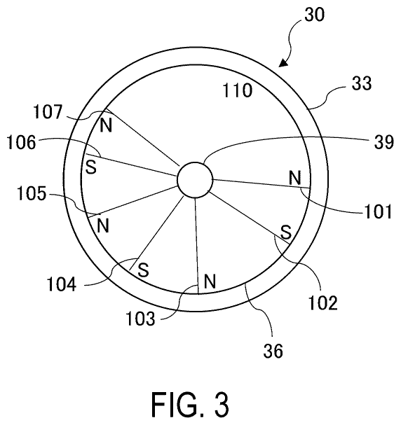

Incidentally, structures of the developing devices 1Y, 1M, 1C, and 1K are the same, and therefore, in the following, the developing device 1Y will be described as a representative. FIG. 2 is a conceptual view illustrating the developing device 1Y shown in FIG. 1, and FIGS. 3 to 5 are conceptual views illustrating magnetic pole structures of a first magnet 36, a second magnet 37, and a third magnet 38 which are provided inside the developing device 1Y, respectively.

The developing device 1Y includes, as shown in FIG. 2, a first developing roller 30, a second developing roller 31, a peeling roller 32, a developer supplying screw 42, a developer stirring screw 43, and a developer collecting screw 44, and these members are accommodated in a developing container 60.

The first developing roller 30 is a developer carrying member (rotatable member) which is rotationally driven, and is provided in a position adjacent to the photosensitive drum 28Y so that a rotational axis thereof is substantially parallel to a rotational axis of the photosensitive drum 28Y. The first developing roller 30 includes a first sleeve 33 as a first developing sleeve which is rotatable, and the first magnet (fixed magnet) 36 as a first developing magnet non-rotationally provided inside the first sleeve 33 and for attracting the developer to a surface of the first sleeve 33 by a magnetic force. Then, the first developing roller 30 attracts (carries) the developer, scooped from the developer supplying screw 42, on the basis of the magnetic force, and develops the electrostatic latent image, formed on the rotating photosensitive drum 28Y (image bearing member), with the developer.

To the first sleeve 33 (and a second sleeve 34 described later) of the developing device 1Y, for example, a DC developing bias of the same polarity as a charge polarity of the primary charger 21Y or a developing bias in the form of an AC voltage superposed with a DC voltage of the same polarity as the charge polarity of the primary charger 21Y is applied. As a result, reverse development in which the toner charged to the same polarity of the charge polarity of the primary charger 21Y is deposited on the electrostatic latent image formed by the optical write portion 22Y is performed. In this embodiment, a constitution in which the reverse development in which the charge polarity of the primary charger 21Y and the DC voltage of the developing bias are negative and the negatively charged toner is developed on the electrostatic latent image is performed was employed.

The first sleeve 33 is a non-magnetic cylindrical member having an outer diameter of 25 mm (radius r1=12.5 mm) and is rotationally driven about a rotation shaft 39. A rotational direction of the first sleeve 33 is the clockwise direction as indicated by an arrow in FIG. 2 and is a direction opposite to a rotational direction of the photosensitive drum 28 in this embodiment. For this reason, the first sleeve 33 and the photosensitive drum 28Y rotate in the same direction in mutually opposing positions thereof. In this embodiment, a linear speed of a surface of the first sleeve 33 of the first developing roller 30 is made 1.0 time (=650 mm/s) the line speed of the surface of the photosensitive drum 28Y. When a ratio of the line speed of the surface of the first sleeve 33 to the line speed of the surface of the photosensitive drum 28Y is suppressed to 1.0 time or more and about 1.2 times or less, such a line speed ratio is advantageous from a viewpoint of prevention of toner deterioration. On the other hand, a supply amount of the toner to the photosensitive drum 28Y is decreased, so that there is a liability that a developing property lowers, but in this embodiment, the two developing rollers 30 and 31 are provided, so that even when the line speed ratio is suppressed, the supply amount of the toner to the photosensitive drum 28Y can be maintained.

The first magnet 36 is disposed inside the first sleeve 33 and includes, as shown in FIG. 3, a plurality of sector magnetic poles 101 to 107. A solid line of each of the magnetic poles 101 to 107 shown in FIG. 3 shows a position (peak position, pole position) of a maximum value of a distribution of a normal component of magnetic flux density of the first magnet 36. Between an inner periphery of the first sleeve 33 and an outer periphery of the first magnet 36, a space permitting rotation of the first sleeve 33 is provided.

The developer attracted onto the first sleeve 33 (first sleeve) is fed (conveyed) toward the photosensitive drum 28Y by a rotation operation of the first sleeve 33, and develops the electrostatic latent image formed on the photosensitive drum 28Y. After the developer develops the electrostatic latent image formed on the photosensitive drum 28Y, the developer on the first sleeve 33 is fed to the neighborhood of the second developing roller 31 by the rotation operation of the first sleeve 33. Then, in the neighborhood of a closest position between the first developing roller 30 and the second developing roller 31, the developer is peeled off from the surface of the first sleeve 33 and then delivered to a surface of a second sleeve 34 (second sleeve) by a magnetic field generated by the first magnet 36 included in the first developing roller 30 and by the second magnet 37 included in the second developing roller 31.

The second developing roller 31 of the developing device 1Y in this embodiment is, as described below, disposed above the first developing roller 30 with respect to a vertical direction. For that reason, there is a need that delivery of the developer from the first developing roller 30 to the second developing roller 31 is also performed from below to above in the vertical direction against gravitation.

Incidentally, the first sleeve 33 and the second sleeve 34 are disposed with a gap of 3 mm in a closest portion therebetween.

The second developing roller 31 as a developing roller is a developer carrying member (rotatable member) which is rotationally driven, and is provided downstream of the first developing roller 30 with respect to the rotational direction of the photosensitive drum 28Y and a rotation center O2 of the second developing roller 31 is provided so as to be positioned above a rotation center O1 of the first developing roller 30 with respect to the vertical direction. To the second developing roller 31, the developer is delivered from the first developing roller 30 by the magnetic force. In this embodiment, a whole of the second developing roller 31 is positioned above the rotation center O1 of the first developing roller 30. The second developing roller 31 is, similarly as the first developing roller 30, provided in a position adjacent to the photosensitive drum 28Y so that a rotational axis thereof is substantially parallel to a rotational axis of the photosensitive drum 28Y. Accordingly, the second developing roller 31 and the first developing roller 30 are substantially parallel to each other in rotational axis.

Such a second developing roller 31 includes a second sleeve (second developing sleeve) 34 as a rotatable developing sleeve, and the second magnet (second developing magnet, fixed magnet) 37 as a developing magnet non-rotationally provided inside the second sleeve 34 and for attracting the developer to a surface of the second sleeve 34 by a magnetic force. Then, on the basis of the magnetic force, to the second developing roller 31, the developer is delivered from the first developing roller 30 (the first sleeve 33), and the second developing roller 31 attracts (carries) the developer, and develops the electrostatic latent image formed on the rotating photosensitive drum 28Y, with the developer. Incidentally, on a side of the second developing roller 31, the peeling roller 32 described later is positioned.

The second sleeve 34 is a non-magnetic cylindrical member having an outer diameter of 25 mm (radius r2=12.5 mm) and is rotationally driven about a rotation shaft 40. A rotational direction of the second sleeve 34 is the clockwise direction similarly as the first sleeve 33 as indicated by an arrow in FIG. 2 and is a direction opposite to a rotational direction of the photosensitive drum 28Y. For this reason, the second sleeve 34 and the photosensitive drum 28Y rotate in the same direction in mutually opposing positions thereof. Further, the second sleeve 34 and the first sleeve 33 rotate in opposite directions in mutually opposing positions thereof. In this embodiment, a line speed of the surface of the second sleeve 34 of the second developing roller 31 is made 1.2 times (=780 mm/s) a line speed of the surface of the photosensitive drum 28Y.

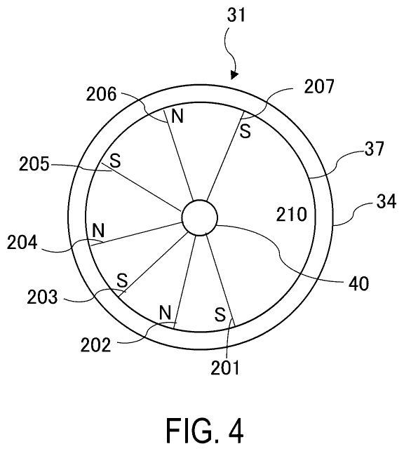

The second magnet 37 is disposed inside the second sleeve 34 and includes, as shown in FIG. 4, a plurality of magnetic poles 201 to 207. A solid line of each of the magnetic poles 201 to 207 shown in FIG. 4 shows a position of a maximum value (peak position, pole position) of a distribution of a normal component of magnetic flux density of the second magnet 37. Between an inner periphery of the second sleeve 34 and an outer periphery of the second magnet 37, a space permitting rotation of the second sleeve 34 is provided.

The developer attracted onto the second sleeve 34 is fed toward the photosensitive drum 28Y by a rotation operation of the second sleeve 34, so that the electrostatic latent image formed on the photosensitive drum 28Y is developed with the developer. After the electrostatic latent image formed on the photosensitive drum 28Y is developed with the developer, the developer remaining on the second sleeve 34 is fed to the neighborhood of the peeling roller 32 by a rotation operation of the second sleeve 34. Then, in the neighborhood of a closest position between the second developing roller 31 and the peeling roller 32, the developer is delivered from the second sleeve 34 to a third sleeve 35 of the peeling roller 32 by a magnetic field generated by the second magnet 37 included in the second developing roller 31 and by the third magnet 38 included in the peeling roller 32.

The peeling roller (collecting roller) 32 as a peeling portion is provided on a side opposite from the photosensitive drum 28Y with respect to a rotation center of the second sleeve 34 and peels off, from the second developing roller 31, the developer after the electrostatic latent image on the photosensitive drum 28Y is developed by the second developing roller 31. Specifically, the peeling roller 32 is a developer carrying member (rotatable member) which is rotationally driven, and is provided between the second developing roller 31 and the developer collecting screw 44 so that a rotation center R thereof is positioned above the rotation center O2 of the second developing roller 31 with respect to the virtual direction.

Further, the peeling roller 32 is disposed so that a rotational axis thereof is substantially parallel to a rotational axis of the photosensitive drum 28Y. Such a peeling roller 32 includes a third sleeve 35 as a rotatable peeling sleeve, and the third magnet (peeling magnet, fixed magnet) 38 non-rotationally provided inside the third sleeve 35 and for attracting the developer to a surface of the third sleeve 35 by a magnetic force, and is constituted so that the developer is delivered from the second developing roller 31 thereto on the basis of the magnetic force.

The third sleeve 35 is a non-magnetic cylindrical member having an outer diameter of 18 mm (radius: 9 mm) and is rotationally driven about a rotation shaft 41. A rotational direction of the third sleeve 35 is the counterclockwise direction as indicated by an arrow in FIG. 2 and is a direction opposite to a rotational direction of the second sleeve 34. For this reason, the third sleeve 35 and the second sleeve 34 rotate in the same direction in mutually opposing positions (opposing portions) thereof.

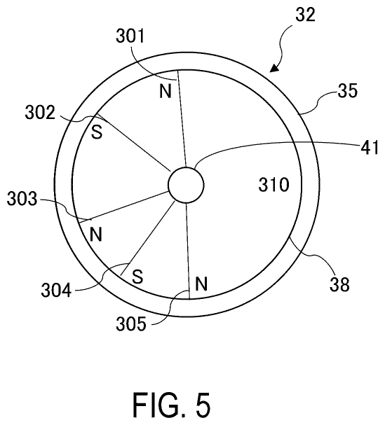

The third magnet 38 is disposed inside the third sleeve 35 and includes, as shown in FIG. 5, a plurality of magnetic poles 301 to 305. A solid line of each of the magnetic poles 301 to 306 shown in FIG. 5 shows a position of a maximum value (peak position, pole position) of a distribution of a normal component of magnetic flux density of the third magnet 38. Between an inner periphery of the third sleeve 35 and an outer periphery of the third magnet 38, a space permitting rotation of the third sleeve 35 is provided.

The developer attracted onto the third sleeve 35 is fed to a downstream side of the rotational direction by a rotation operation of the third sleeve 35 is peeled off from the third sleeve 35 in a position close to the developer collecting screw 44 by the third magnet 38 included in the peeling roller 32, so that the developer is dropped toward a guiding member 45 positioned below with respect to the vertical direction, by a self-weight thereof. Then, the developer dropped on the guiding member 45 is guided toward the developer collecting screw 44 by its own weight.

The guiding member 45 and the developer collecting screw 44 constitute a developer collecting portion 47 as a collecting portion for collecting the developer peeled off from the third sleeve 35 on the peeling roller 32. The developer collecting screw 44 is disposed in a developer collecting chamber 47a and feeds the developer accommodated in the developer collecting chamber 47a. Specifically, in the developer collecting portion 47, a rotation center of the developer collecting screw 44 is disposed so as to be positioned below a rotation center of the peeling roller 32 in the vertical direction, and feeds the developer delivered (collected) from the peeling roller 32, while stirring the developer.

The guiding member 45 as a guiding portion is disposed below the peeling roller 32 with respect to the vertical direction and a closest position P2 between the guiding member 45 and the peeling roller 32 is disposed above the rotation center (rotation center of the second sleeve 34) 02 of the second developing roller 31 with respect to the vertical direction, and the guiding member 45 guides the developer, peeled off by the peeling roller 32, toward the developer collecting screw 44. The guiding member 45 is disposed in a position opposing a peeling magnetic pole 305 of a third magnet 38 described later through the third sleeve 35. A free end position P1 which is an end portion of the guiding member 45 on a side opposite from the developer collecting screw 44 is positioned above the rotation center O2 of the second developing roller 31.

Such a guiding member 45 includes an inclined surface 45a as a guiding surface for guiding the developing peeled off from the peeling roller 32 inclined surface 45a is inclined so that the developer slides down by its own weight in order to reliably guide the peeled developer toward the developer collecting screw 44. That is, the inclined surface 45a is inclined with respect to a horizontal direction so that a position thereof on the developer collecting screw 44 side (feeding member side) is lower than the closest position P2 to the peeling roller 32. In this embodiment, a gap between the peeling roller 32 and the guiding member 45 in the closest position P2 therebetween was 1.8 mm, and an inclination angle of the inclined surface 45a of the guiding member 45 was 8°.

The developer collecting screw 44 as a feeding member feeds the collected developer to a developer circulating portion 46 described below. That is, the developer collecting screw 44 is a screw feeding member used for feeding the developer, collected by being slid down along the inclined surface 45a of the guiding member 45, in one direction while stirring the developer. Further, the developer collecting screw 44 is disposed so that a rotational axis thereof is substantially parallel to the rotational axis of the second sleeve 34, and a rotation center of the developer collecting screw 44 is positioned above the rotation center O2 of the second developing roller 31.

The developer circulating portion 46 is a supplying portion for supplying the developer to the first developing roller 30, and includes a regulating member 50, the developer supplying screw 42, and the developer stirring screw 43. In the developer circulating portion 46, the developer is supplied to the first developing roller 30 while the developer is fed in the substantially horizontal direction while being stirred in the developer supplying screw 42 and the developer stirring screw 43. Further, as described above, the developer collected by the developer collecting portion 47 is dropped by its own weight and is guided to the developer circulating portion 46.

The developer supplying screw 42, the developer stirring screw 43, and the developer collecting screw 44 are screw feeding members for feeding the developer in one direction while stirring the developer, and the developer supplying screw 42 and the developer stirring screw 43 are positioned below the developer collecting screw 44 with respect to the vertical direction. Further, the developer supplying screw 42, the developer stirring screw 43, and the developer collecting screw 44 are disposed so that their rotational axes are substantially parallel to each other. The rotational axes of these screws are also substantially parallel to the rotational axis of the first developing roller 30.

The developer supplying screw 42 is positioned between the first developing roller 30 and the developer stirring screw 43, and between itself and the developer stirring screw 43, a partition wall 48 of the developing container 60 is provided. The partition wall 48 of the developing container 60 is extended along rotational axis directions of the developer supplying screw 42 and the developer stirring screw 43. The partition wall 48 is provided with a communication opening (not shown) for establishing communication between a first feeding path 61 along which the developer is fed by the developer supplying screw 42 and a second feeding path 62 along which the developer is fed by the developer stirring screw 43.

The developer stirred by the developer collecting screw 44 passes through a communication opening (not shown) formed in a partition wall 63 of the developing container 60 positioned between the developer collecting screw 44 and the developer supplying screw 42 and then is dropped toward the developer supplying screw 42 by its own weight. That is, the developer collecting chamber (second chamber) 47a in which the developer collecting screw 44 is disposed is partitioned by the first feeding path 61 and the partition wall 63, and the developer drops from the developer collecting chamber 47a into the first feeding path 61 through the communication opening formed in the partition wall 63. Incidentally, the above-described guiding member 45 is formed integrally with the partition wall 63, and above the partition wall 63, the developer collecting screw 44 is disposed. A position of the communication opening through which the developer stirred by the developer collecting screw 44 is dropped by its own weight and is guided into the developer circulating portion 46 may preferably be disposed while avoiding a region (an intermediary portion with respect to the developer supplying screw 42 with respect to a rotational axis direction) in which the developer is supplied toward the first developing roller 30. In this embodiment, the position of the communication opening is a position where the communication opening position is included in a range of a downstream end portion (terminal portion), with respect to a developer feeding direction, of the first feeding path 61 in which the developer supplying screw 42 is disposed.

Developer feeding directions of the developer supplying screw 42 and the developer stirring screw 43 are mutually opposite directions. Further, a starting end side (upstream end side in the developer feeding direction) and a terminal end side (downstream end side in the developer feeding direction) of the first feeding path 61 in which the developer supplying screw 42 is disposed, and a terminal end side and a starting end side of the second feeding path 62 in which the developer stirring screw 43 is disposed communicate with each other, respectively, via communication openings provided in the partition wall 48. Accordingly, the developer is circulated in the rotational directions of the developer supplying screw 42 and the developer stirring screw 43 indicated by arrows in FIG. 2 and in the substantially horizontal direction in the developing container 60, so that a part of the developer is supplied toward the first developing roller 30.

A developer supply opening 51 (see FIG. 2) is provided above the developer stirring screw 43 in the developing container 60 and is connected to the developer storage portion 27Y (see FIG. 1). Further, the developer supply opening 51 is constituted so as to be capable of supplying the developer, accommodated in a bottle mounted in the developer storage portion 27Y, to the second feeding path 62 in which the developer stirring screw 43 is disposed.

As described above, above, a toner weight ratio of the developer accommodated in the bottle of the developer storage portion 27Y is larger than a toner weight ratio of the developer in the developing device 1Y, and therefore, by adjusting an amount of the developer supplied to the developer stirring screw 43, the toner weight ratio of the developer in the developing device 1Y can be maintained at a certain level.

A toner concentration detecting sensor 49 (see FIG. 2) is provided for detecting a toner concentration of the developer contained in the developer circulating portion 46. The toner concentration detecting sensor 49 is a sensor for detecting (magnetic) permeability of the developer. The toner concentration corresponds to a consumption amount of the toner in the developing device 1Y, and therefore, is utilized in control of supply of the developer from the developer storage portion 27Y. For example, when the toner concentration is detected that the toner concentration is lowered than a predetermined value, the developer is supplied from the developer storage portion 27Y. Incidentally, the permeability of the developer changes depending on the toner concentration, and therefore, by utilizing the permeability, it is possible to detect the toner concentration.

The regulating member 50 is disposed adjacent to the first developing roller 30 and is used for regulating an amount of the developer supplied from the developer circulating portion 46 to the first developing roller 30. The regulating member 50 can be constituted so as to regulate an amount of the developer attracted to the first developing roller 30, for example, on the basis of a gap between the surface of the first sleeve 33 of the first developing roller 30 and an end portion of the regulating member 50.

A circulating path of the developer in the developing container 60 is such that the developer is fed in the substantially horizontal direction while being stirred in the developer circulating portion 46 and thereafter is supplied to the first developing roller 30, and then is delivered from the first developing roller 30 to the second developing roller 31 positioned above the first developing roller 30, on the basis of the magnetic force. Then, the developer is delivered from the second developing roller 31 to the peeling roller 32 positioned beside the second developing roller 31, on the basis of the magnetic force again, and thereafter, is peeled off from the peeling roller 32 by the third magnet 38 included in the peeling roller 32, and then, the developer is collected by the developer collecting portion 47 and then is guided again into the developer circulating portion 46.

Further, as described above, in this embodiment, a two-component development type is used as a development type, and as the developer, a developer obtained by mixing non-magnetic toner having a negative charge polarity with a carrier having a magnetic property is used. The non-magnetic toner is negatively charged by triboelectric charge with the magnetic carrier and the magnetic carrier is positively charged. The non-magnetic toner is toner obtained by containing a colorant, a wax component, and the like in a resin such as polyester or styrene-acrylic resin, by forming the mixture in powder through pulverization or polymerization, and then by adding fine powder of titanium oxide, silica, or the like to a surface of the powder. The magnetic carrier is a carrier obtained by coating a resin material on a surface layer of a core comprising resin particles obtained by kneading ferrite particles or magnetic powder. The toner concentration of the developer (a weight ratio of the toner to the developer) in an initial state is 8% in this embodiment.

Incidentally, the magnetic carrier may preferably have a magnetization amount per unit weight of 40 Am²/kg or more and 80 Am²/kg or less in an applied magnetic field of 1000 Oe (oersted) (79577A/m). When the magnetization amount of the magnetic carrier is made small, there is an effect of suppressing scavenging by a magnetic brush, but deposition of the magnetic carrier on the non-magnetic sleeve by the magnets inside the developing rollers becomes difficult, so that an image defect such that deposition of the magnetic carrier onto the photosensitive drum occurs or the like in some instances. Incidentally, the scavenging is a phenomenon such that by the magnetic carrier once subjected to the development scrapes off the toner subjected to the development. Further, when the magnetization amount of the magnetic carrier is larger than the above-described range, as described above, the image defect is caused by pressure of the magnetic brush. In this embodiment, a magnetic carrier having the magnetization amount per unit weight of 63 Am²/kg was used.

The magnetization amount of the magnetic carrier was measured by using a vibrating sample magnetometer (vibration magnetic field-type automatic magnetic property measurement system) (“BHV-30”, manufactured by Riken Denshi Co., Ltd.). A magnetic characteristic value is obtained in the following manner. An external magnetic field of 1000 Oe is formed and strength of magnetization at that time is acquired. The magnetic carrier is put in a packed state so as to become sufficiently dense in a cylindrical plastic container. In this state, magnetic moment is measured, and an actual weight when a sample is placed is measured, so that the strength of magnetization (Am²/kg) is acquired.

True specific gravity is acquired by a dry automatic pycnometer (“Accupyc 1330”, manufactured by Shimadzu Corporation). In this embodiment, a magnetic carrier of 4.6 (g/cm³) in true specific gravity (density) was used. Further, the magnetic carrier of 35 μm (radius b=17.5 μm) in weight-average diameter was used.

In general, the two-component development type using the toner and the carrier has a feature such that stress exerted on the toner is less than stress exerted on the toner in a one-component development type using a one-component developer because the toner and the carrier are charged to predetermined polarities by subjecting the toner and the carrier to triboelectric contact. On the other hand, by long-term use, an amount of a contaminant (spent) deposited on the carrier surface increases, and therefore, toner charging capacity gradually lowers. As a result, problems of a fog and a toner scattering arise. Although an amount of the carrier accommodated in the developing device is increased in order to prolong a lifetime of the two-component developing device, this causes upsizing of the developing device, and therefore is not desirable.

In order to solve the above-described problems on the two-component developer, in this embodiment, an ACR (auto carrier refresh) type is employed. The ACR type is a type such that an increase in amount of a deteriorated carrier is suppressed by not only supplying a fresh developer little by little from the developer storage portion 27Y into the developing device 1Y but also discharging the developer, deteriorated in charging performance, little by little through a discharge opening (not shown) of the developing device 1Y. By this, the deteriorated carrier in the developing device 1Y is replaced with a fresh carrier, so that the charging performance of the carrier in the developing device 1Y can be maintained at an approximately constant level.

### [Magnetic Poles of Magnets]

Next, magnetic pole constitutions of the first magnet 36, the second magnet 37, and the third magnet 38 included in the first developing roller 30, the second developing roller 31, and the peeling roller 32, respectively, which are shown in FIGS. 3, 4, and 5, respectively, will be described.

As shown in FIG. 3, the first magnet 36 included in the first developing roller 30 is provided with a plurality of magnetic poles 101, 102, 103, 104, 105, 106, and 107, which are seven poles in total. Of these magnetic poles, the magnetic pole 107 is a delivering pole for delivering the developer from the first developing roller 30 to the second developing roller 31. The magnetic poles 101 to 107 are disposed in a named order in the rotational direction of the first sleeve 33. As described above, the solid line of each of the magnetic poles 101 to 107 shown in FIG. 3 shows a position of a peak value (maximum value) of a normal component Br, to the surface of the first sleeve 33 of the first magnet 36, of magnetic flux density of the first magnet (hereinafter, this normal component Br is simply referred to as “magnetic flux density Br” or “normal component Br” in some cases). This is true for the magnetic poles 201 to 207 of the second magnet 37 shown in FIG. 4 and for the magnetic poles 301 to 305 of the third magnet 38 shown in FIG. 5.

The magnetic pole 107 as the delivering pole is a magnetic pole for delivering the developer from the first sleeve 33 to the second sleeve 34 by a magnetic field generated in cooperation with the second developing roller 31 and the second magnet 37, and hereinafter, the magnetic pole 107 is referred to as the delivering pole 107 in some cases.

Further, the magnetic pole 101 is an N pole and is used for attracting the developer, supplied from the developer supplying screw 42, to the first sleeve 33. The magnetic poles 102, 103, 104, 105, and 106 are an S pole, an N pole, an S pole, an N pole, an S pole, and an N pole, respectively, and are used for feeding upward the developer attracted by the magnetic pole 101 with rotation of the first sleeve 33. The magnetic pole 107 is an N pole and delivers the developer from the first sleeve 33 to the second sleeve 34 opposing the first sleeve 33 by a magnetic field generated in cooperation with the magnetic pole 201 in the second magnet 37 included in the second developing roller 31 as described above.

Further, in this embodiment, a low-magnetic force portion 110 lower in magnetic force than the delivering pole 107 is formed by a repelling magnetic field generated by cooperation between the delivering pole 107 and the magnetic pole 101 disposed on a side downstream of the delivering pole 107 with respect to the rotational direction of the first sleeve 33 and having the same magnetic polarity as the delivering pole 107. By this low-magnetic force portion 110, the delivery of the developer from the first sleeve 33 to the second sleeve 34 is promoted. Incidentally, the low-magnetic force portion 110 has substantially no magnetic force in this embodiment, but may have a low magnetic force, for example, a magnetic force (normal component Br of magnetic flux density) of 5 mT or less. This is true for a low-magnetic force portion 210 of the second magnet 37 shown in FIG. 4 and for a low-magnetic force portion 310 of the third magnet 38 shown in FIG. 5.

As shown in FIG. 4, the second magnet 37 included in the second developing roller 31 is provided with a plurality of magnetic poles 201, 202, 203, 204, 205, 206, and 207, which are seven poles in total. Of these magnetic poles, the magnetic pole 201 is a receiving pole for receiving the developer from the first developing roller 30 by the second developing roller 31. The magnetic poles 201 to 207 are disposed in a named order in the rotational direction of the second sleeve 34.

The magnetic pole 201 as the receiving pole is a magnetic pole for receiving and attracting the developer from the first sleeve 33 to the second sleeve 34 by a magnetic field generated in cooperation with the magnetic pole 107 of the first magnet 36 of the first developing roller 30, and hereinafter the magnetic pole 201 is referred to as a receiving pole 201 in some cases. The magnetic pole 207 is a magnetic pole for delivering the developer from the second sleeve 34 to the third sleeve 35 by a magnetic field generated in cooperation with the third magnet 38 of the peeling roller 32.

Further, the receiving pole 201 is an S pole different in polarity from the delivering pole 107 and is used for attracting the developer from the first developing roller 30 (first sleeve 33) to the second sleeve 34 as described above. The magnetic poles 202, 203, 204, 205 and 206 are an N pole, an S pole, an N pole, an S pole, and an N pole, and are used for feeding upward the developer attracted by the magnetic pole 201 with rotation of the second sleeve 34. The magnetic pole 207 is an S pole and delivers the developer, after passing through a developing region with the photosensitive drum 28Y corresponding to the magnetic pole 203, from the second sleeve 34 to the third sleeve 35 opposing the second sleeve 34 by a magnetic field generated in cooperation with a magnetic pole 303 in the third magnet 38 included in the peeling roller 32.

Further, in this embodiment, the low-magnetic force portion 210 lower in magnetic force than the magnetic pole 207 is formed by a repelling magnetic field generated by cooperation between the receiving pole 201 and the magnetic pole 207 disposed on a side upstream of the receiving pole 201 with respect to the rotational direction of the second sleeve 34 and having the same magnetic polarity as the receiving pole 201. By this low-magnetic force portion 210, delivery of the developer from the first sleeve 33 to the second sleeve 34 is promoted. Further, by the low-magnetic force portion 210, it is possible to prevent attraction of the developer to the closest portion between the first sleeve 33 and the second sleeve 34, so that pressure exerted on the developer can be suppressed.

As shown in FIG. 5, the third magnet 38 included in the peeling roller 32 is provided with the plurality of magnetic poles 301, 302, 303, 304, and 305. The magnetic poles 301 to 305 are disposed in a named order in the rotational direction of the third sleeve 35.

The magnetic pole 303 is an N pole different in pole from the magnetic pole 207 and is a pole for attracting the developer, peeled off from the second sleeve 34 as described above, to the third sleeve 35, and hereinafter the magnetic pole 303 is referred to as a receiving pole 303 in some cases. The magnetic poles 301, 302, and 304 are an N pole, an S pole, and an S pole, and are used for feeding the developer on the third sleeve 35 with rotation of the third sleeve 35. Particularly, the magnetic pole 304 is a pole for feeding downward the developer attracted by the magnetic pole 303 with rotation of the third sleeve 35, and hereinafter the magnetic pole 304 is referred to as a feeding pole 304 in some cases. The magnetic pole 305 is an N pole and is a pole for peeling off the developer, attracted to the third sleeve 35, from the third sleeve 35 by a repelling magnetic field generated in cooperation with the magnetic pole 301 having the same pole, and hereinafter the magnetic pole 305 is referred to as a peeling pole 305 in some cases.

### [Arrangement Relationship Between Second Developing Roller, Peeling Roller and Guiding Member]

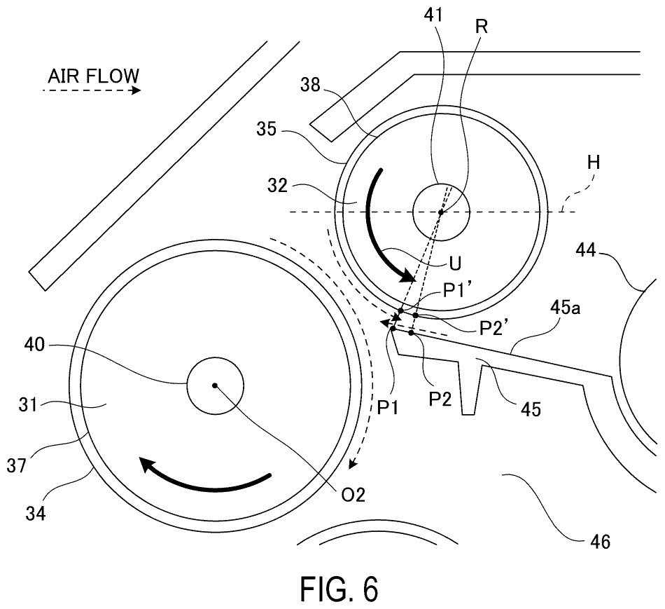

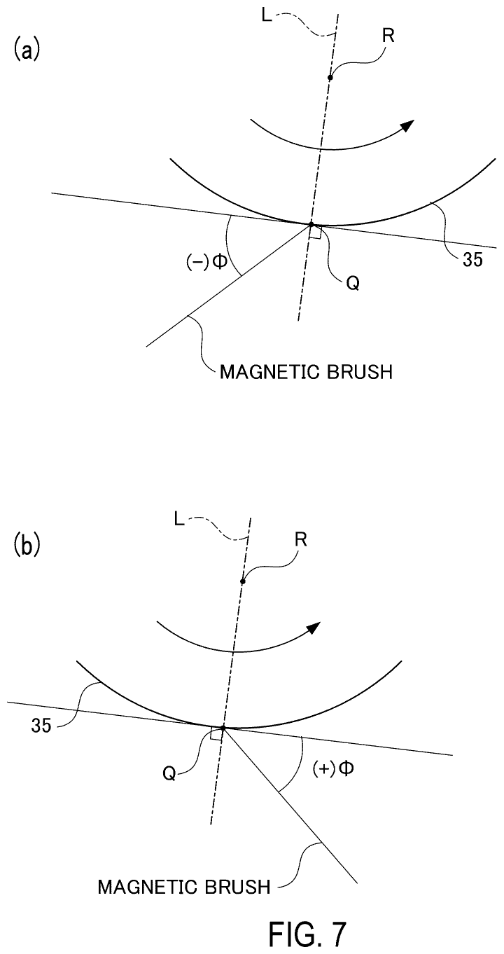

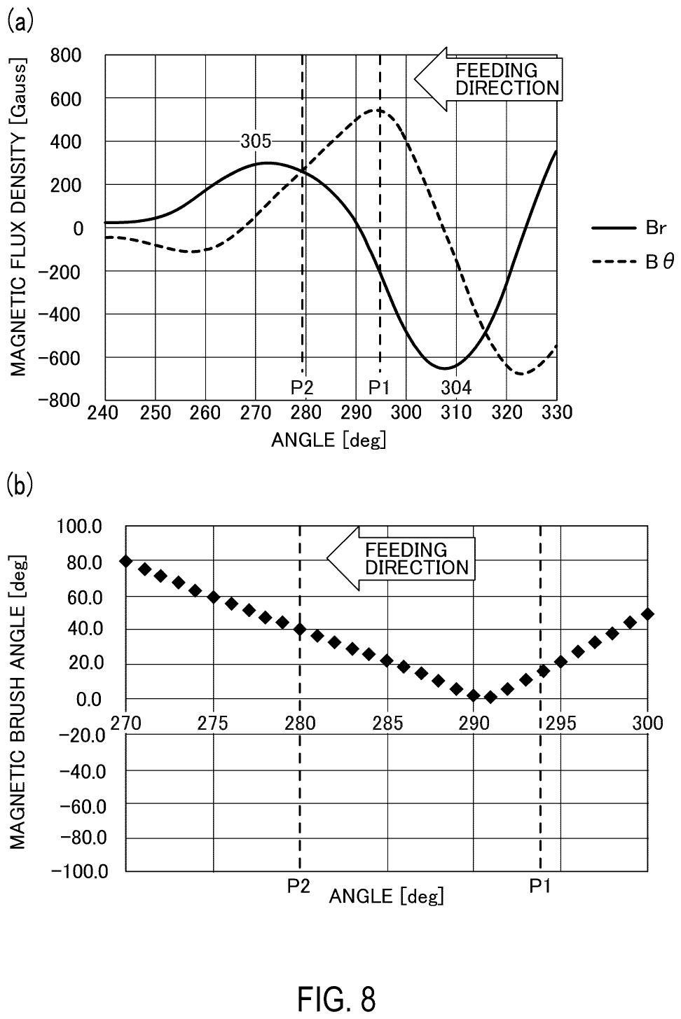

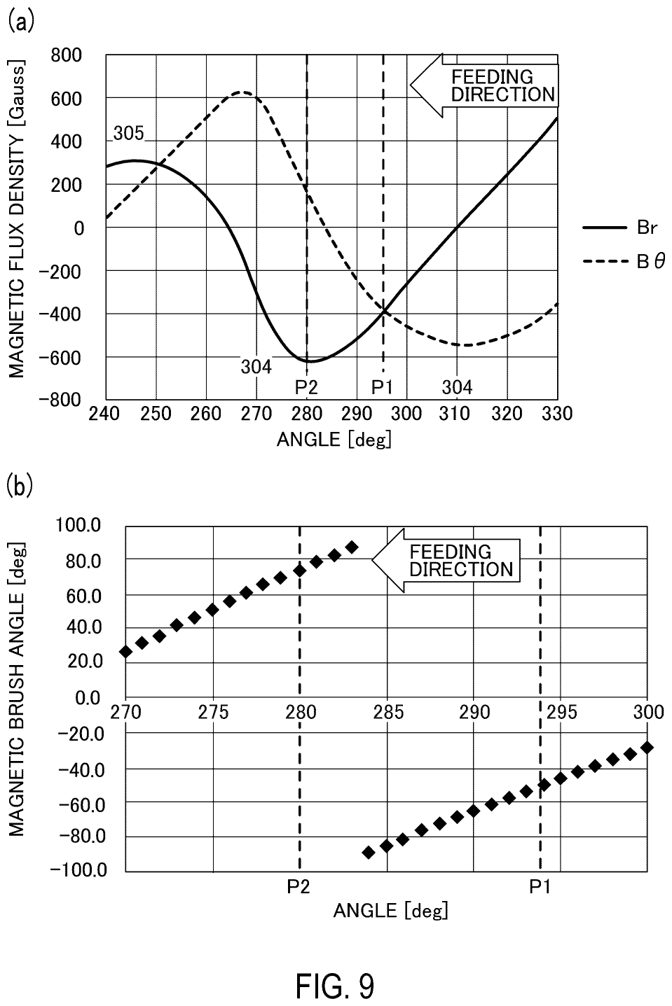

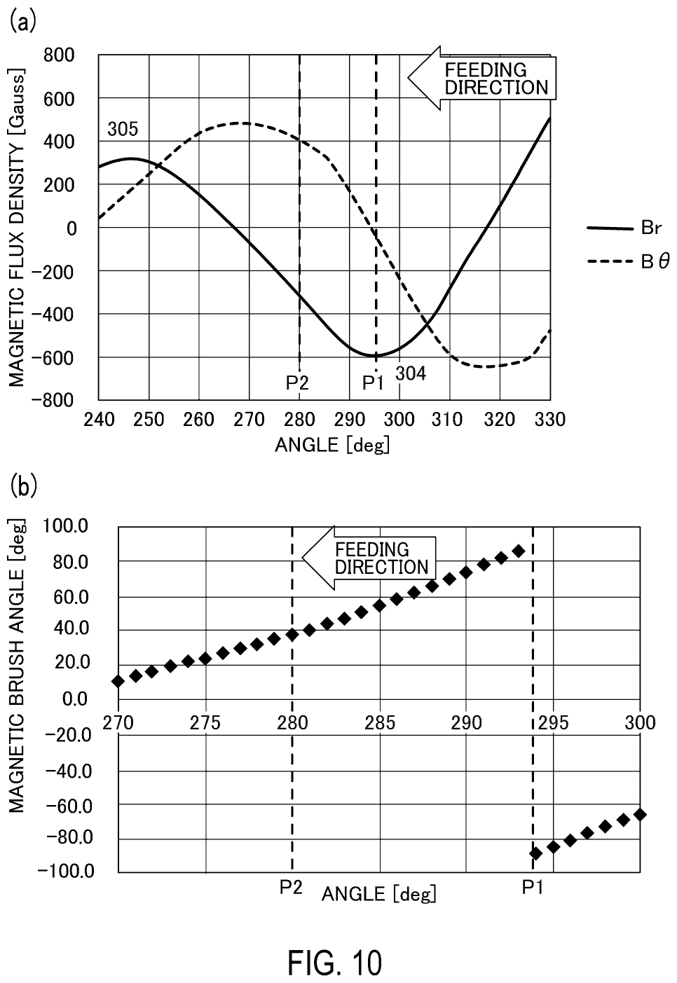

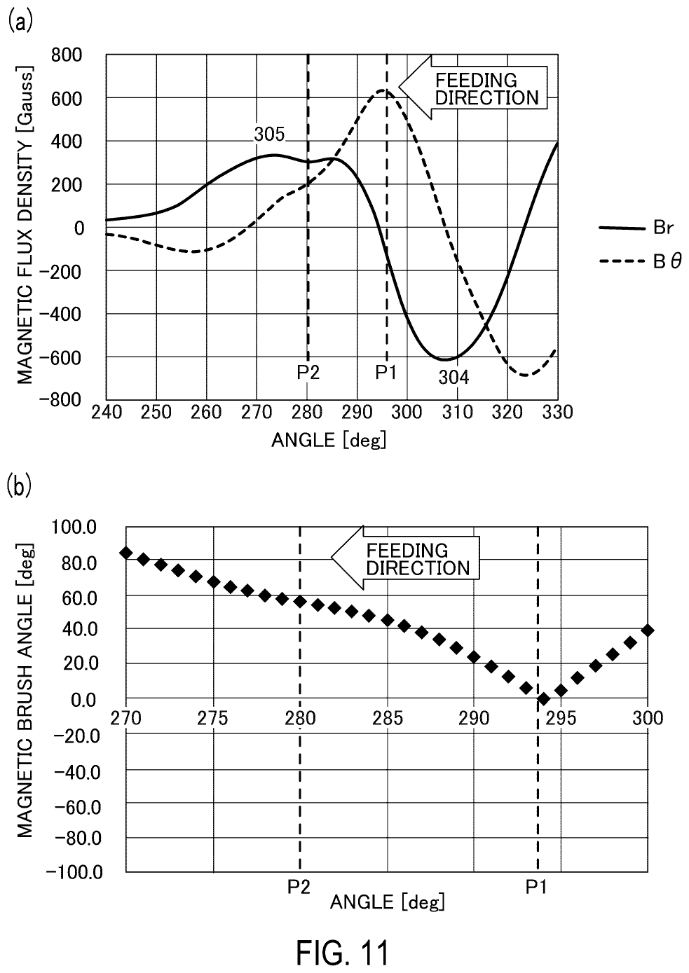

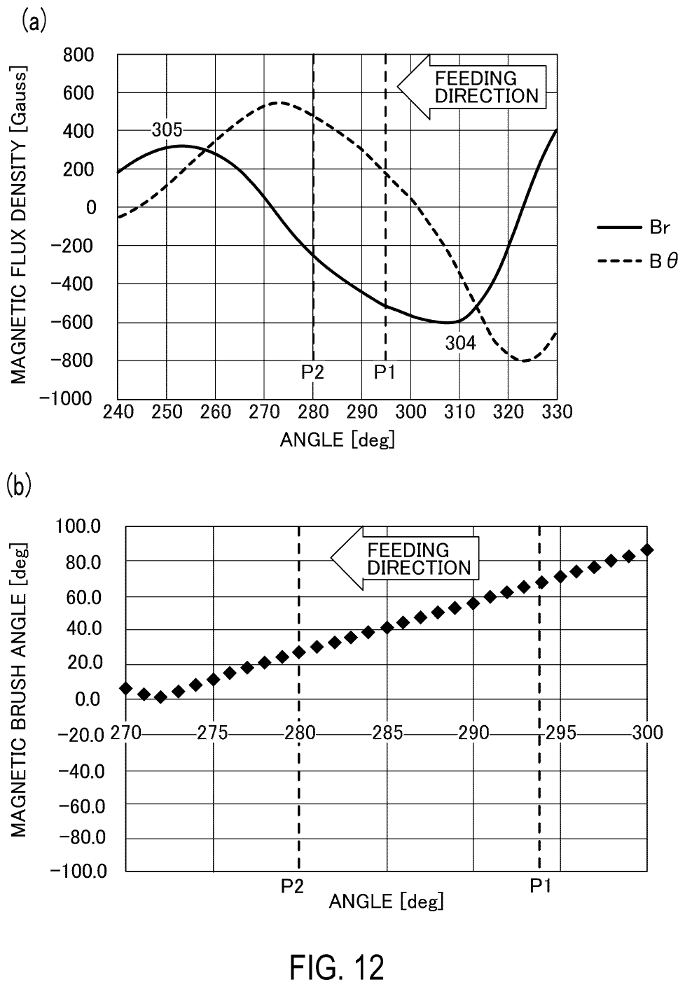

Next, referring to FIG. 6, an arrangement relationship between the second developing roller 31, the peeling roller 32, and the guiding member 45 will be described.

In this embodiment, as described above, the developer in the developing device 1Y moves from the surface of the first sleeve 33 of the first developing roller 30 to the surface of the second sleeve 34 of the second developing roller 31, and then moves to the surface of the third sleeve 35 of the peeling roller 32. In recent years, speed-up of the image forming apparatus advances, so that rotational speeds of the first developing roller 30, the second developing roller 31, and the peeling roller 32 become fast, and therefore, in a process in which the developer is fed on each of the respective sleeves, when a magnetic brush (chain) formed on the sleeve between the magnetic poles of the magnet in the associated roller falls down, the toner is liable to be detached and scattered from the carrier.

Further, as described above, an air flow is generated by the second developing roller 31 and the peeling roller 32 which are rotated at high speeds, so that the detached toner is scattered by being carried by the air flow. The air flow flows toward the rotational direction of each sleeve, and the air flow in the neighborhood of the peeling roller 32 flows along the rotational direction of the third sleeve 35. The scattered toner moves along a flow thereof and collides against the guiding member 45, so that the scattered toner is deposited on the guiding member 45 from the free end position P1 of the guiding member 45 toward the closest position P2 between the peeling roller 32 and the guiding member 45. Here, the free end position P1 is an end portion of the guiding member 45 on a side opposite from the developer collecting screw 44, in other words, an end portion of the guiding member 45 on the second developing roller 31 side. The closest position P2 is a position of the guiding member 45 where the guiding member 45 is closest to the peeling roller 32.

Further, in the neighborhood of the peeling roller 32, when the air flow flows along the rotational direction of the third sleeve 35, internal pressure of the developer collecting portion 47 is increased by the air flow taken in the developer collecting portion 47, and therefore, in order to release the air flow taken in the developer collecting portion 47, a flow of the air flow moving out of the developer collecting portion 47 through a gap of the developer collecting portion 47 is generated. This flow of the air flow moves in a direction opposite to the rotational direction of the peeling roller 32 toward the free end of the guiding member 45 along the guiding member 45.

By the flow of this air flow, when the toner deposited on the guiding member 45 is dropped in the developing device 1Y, the dropped developer enters the developer in the developer circulating portion 46 before supply to the first developing roller 30 or the developer fed by the first developing roller 30 and the second developing roller 31. When such toner enters and is mixed in normal developer, unevenness occurs in toner amount of the toner contained in the developer, and therefore, unevenness occurs in toner amount of the toner moved to the photosensitive drum 28Y when the electrostatic latent image is developed into the toner image on the photosensitive drum 28Y, so that unevenness in density of the toner occurs also on a final output image.

Therefore, in this embodiment, in a portion between the free end position P1 of the guiding member 45 and the closest position P2 between the peeling roller 32 and the guiding member 45, a constitution in which the magnetic brush on the peeling roller 32 contacts the toner is employed. Then, the toner deposited between from the free end position P1 of the guiding member 45 to the closest position P2 between the peeling roller 32 and the guiding member 45 is collected by the magnetic brush on the peeling roller 32.

Here, in the closest position P2, when a constitution in which the magnetic brush on the peeling roller 32 is always contacted to the guiding member 45 by narrowing a gap between the peeling roller 32 and the guiding member 45 is employed, the gap between the peeling roller 32 and the guiding member 45 is sealed by the magnetic brush. As a result of this, of air flow in the neighborhood of the peeling roller 32, air flow flowing along the rotational direction of the third sleeve 35 becomes absent, and therefore, scattered toner is liable to be scattered by being carried by air flow flowing along the rotational direction of the second sleeve 34. Then, the scattered toner enters the developer in the developer circulating portion 46 before supply to the first developing roller 30 and the developer fed by the first developing roller 30 and the second developing roller 31. For this reason, it is not preferable that the gap between the peeling roller 32 and the guiding member 45 in the closest position P2 is excessively narrowed.

Accordingly, it is preferable that the magnetic brush is formed on the peeling roller 32 so that the magnetic brush on the peeling roller 32 (i.e., on the third sleeve 35) contacts the deposited toner when the scattered toner is deposited on the guiding member 45. Here, an angle Θ of the magnetic brush can be represented by arctan (Br/Bθ) from a normal component Br referring to a normal direction component of magnetic flux density B to the surface of the third sleeve 35 and Bθ referring to a tangential direction component. That is, in the case where a normal component of the magnetic flux density in an arbitrary point on the third sleeve 35 (on the peeling roller 32) is Br and a tangential component is Bθ, the angle Θ of the magnetic brush in the arbitrary point can be represented by arctan (Br/Bθ).

Further, in this embodiment, as regards the angle Θ of the magnetic brush, in the following manner, positive and negative are defined. Parts (a) and (b) of FIG. 7 are schematic views for illustrating the case where the angle Θ of the magnetic brush formed on the third sleeve 35 is negative and the case where the angle Θ of the magnetic brush formed on the third sleeve 35 is positive. As shown in part (a) of FIG. 7, the case where the magnetic brush formed in an arbitrary point Q on the third sleeve 35 is inclined so as to fall down in a direction opposite to the rotational direction (arrow direction) of the third sleeve 35 with respect to a virtual line L passing through the arbitrary point Q and a rotation center R of the third sleeve 35 is negative (−). Further, as shown in part (b) of FIG. 7, the case where the magnetic brush formed in an arbitrary point Q on the third sleeve 35 is inclined so as to fall down in the rotational direction (arrow direction) of the third sleeve 35 with respect to a virtual line L passing through the arbitrary point Q and a rotation center R of the third sleeve 35 is positive (+).

In order to more collect the scattered toner, deposited on the guiding member 45, by the magnetic brush, the angle Θ of the magnetic brush formed on the peeling roller 32 in a portion between from the free end position P1 of the guiding member 45 to the closest position P2 between the peeling roller 32 and the guiding member 45 (i.e., with respect to the rotational direction of the third sleeve 35, between from an intersection point P1′ on an outer peripheral surface of the third sleeve 35 which is a point where a rectilinear line passing through an end portion of the guiding member 45 on a side opposite from the developer collecting screw 44 and through the rotation center R of the third sleeve 35 to a closest position P2′ on the outer peripheral surface of the third sleeve 35 which is a point where the outer peripheral surface of the third sleeve 35 is closest to the guiding member 45) may only be required to become 45° or more in absolute value. That is, arctan (Br/Bθ)≥45° or arctan (Br/Bθ)≤−45° may only be required to be satisfied.

In the case where the angle Θ of the magnetic brush is constituted so as to satisfy arctan (Br/Bθ)≥45°, as shown in part (b) of FIG. 7, the magnetic brush becomes a state in which the magnetic brush is inclined so that a free end of the magnetic brush is disposed on a side downstream of a portion of the magnetic brush, on a surface side of the third sleeve 35, with respect to a feeding direction of the developer by the third sleeve 35. Then, the magnetic brush collides against the toner on the guiding member 45 so as to scrape off the toner deposited on the guiding member 45. For this reason, in the case of Θ≥45°, the toner deposited to the guiding member 45 can be efficiently collected. On the other hand, in the case where Θ is constituted so as to satisfy arctan (Br/Bθ)≤−45°, as shown in part (a) of FIG. 7, the magnetic brush becomes a state in which the magnetic brush is inclined so that the free end of the magnetic brush is disposed on a side upstream of the portion of the magnetic brush, on the surface side of the third sleeve 35, with respect to the feeding direction of the developer by the third sleeve 35 (i.e., inclined in a direction opposite to the direction in the above-described case). In this case, the magnetic brush is not readily disturbed when the magnetic brush collides against the toner deposited on the guiding member 45.

Further, the angle Θ of the magnetic brush may preferably become 50° or more in absolute value in a portion between from the free end position P1 to the closest position P2. That is, arctan (Br/Bθ)≥50° or arctan (Br/Bθ)≤−50° may preferably be satisfied. Further, the angle Θ of the magnetic brush may more preferably becomes 60° or more in absolute value in a portion between from the free end position P1 to the closest position P2. That is, arctan (Br/Bθ)≥60° or arctan (Br/Bθ)≤−60° may more preferably be satisfied. Thus, the reason why it is preferable that the absolute value of the angle Θ of the magnetic brush is large in because the toner deposited on the guiding member 45 is readily scraped off by the magnetic brush.

When the above-described condition of the angle Θ of the magnetic brush is satisfied in an either position between from the free end position P1 to the closest position P2, it is possible to scrape off the toner, deposited on the guiding member 45, by the magnetic brush. However, it is preferable that the above-described condition of the angle Θ of the magnetic brush is satisfied in the closest position P2. In the closest position P2 (i.e., the closest position P2′ on the outer peripheral surface of the third sleeve 35), the angle Θ of the magnetic brush may preferably become 450 or more in absolute value. Further, in the closest position P2, the angle Θ of the magnetic brush may more preferably become 50° or more in absolute value. Further, in the closest position P2, the angle Θ of the magnetic brush may further preferably become 60° or more in absolute value.

On the other hand, in the free end position P1, there is a liability that when the angle Θ of the magnetic brush is on the positive side, the magnetic brush is disturbed by collision. For this reason, in the free end position P1 (i.e., in the intersection point P1′ on the outer peripheral surface of the third sleeve 35), the angle Θ of the magnetic brush may preferably satisfy Θ≥−75°. That is, when the magnetic brush fall down in the negative side, the magnetic brush does not readily collide against the free end position P1 of the guiding member 45, and even if the magnetic brush collides against the free end position P1, the magnetic brush moderately collides against the free end position P2, so that the magnetic brush is not readily disturbed and thereafter it becomes possible to efficiently scrape off the toner on the guiding member 45 by the magnetic brush. For this reason, in the free end position P1, the angle Θ of the magnetic brush may more preferably satisfy Θ≥−60°, and may further preferably satisfy Θ≥−50°.

On the other hand, with a narrower gap in the closest position P2 between the peeling roller 32 and the guiding member 45, the magnetic brush becomes liable to contact the toner on the guiding member 45, but when the gap is excessively narrow, this gap is sealed by the magnetic brush and therefore and is not preferred. Therefore, the gap in the closest position P2 between the peeling roller 32 and the guiding member may preferably be constituted so as to become 0.8 mm or more, more preferably 1.2 mm or more, further preferably 1.5 mm or more. However, when the gap in the closest position P2 between the peeling roller 32 and the guiding member 45 is excessively wide, there is a liability that the toner is dropped before the magnetic brush contacts the deposited toner. For this reason, this gap may preferably be 5 mm or less, more preferably 4 mm or less, further preferably 3 mm or less.

By employing the above-described constitution, when the toner scattered to between from the free end position P1 of the guiding member 45 to the closest position P2 between the peeling roller 32 and the guiding member 45 is deposited, the magnetic brush on the peeling roller 32 contacts the toner. For this reason, the deposited toner is collected by the magnetic brush on the peeling roller 32 before the deposited toner is dropped from the guiding member onto the first developing roller 30, and therefore, it is possible to suppress that unevenness in density occurs on the image.

### [Magnetic Flux Density Distribution of Peeling Roller]

Next, a magnetic flux density distribution of the third magnet 38 for forming the magnetic brush on the peeling roller 32 as described above will be specifically described using a comparison example 1, and embodiments 1 to 4 which satisfy features in this embodiment. Incidentally, the comparison example 1 has the same constitution as those of the embodiments except for items described in the following.

Parts (a) and (b) of FIG. 8, parts (a) and (b) of FIG. 9, parts (a) and (b) of FIG. 10, parts (a) and (b) of FIG. 11, and parts (a) and (b) of FIG. 12 are graphs each showing a magnetic flux density distribution of the third magnet 38 and an angle Θ of the magnetic brush in the comparison example 1, the embodiment 1, the embodiment 2, the embodiment 3, and the embodiment 4, respectively. Further, in part (a) of each of FIGS. 8 to 12, a distribution of a normal component Br of the magnetic flux density of the third sleeve 35 by the third magnet 38 and a distribution of a tangential component Bθ of the magnetic flux density are schematically shown by a solid line and a broken line, respectively. Further, in part (b) of each of FIGS. 8 to 12, an angle Θ of the magnetic brush on the third sleeve 35 by the third magnet 38 is schematically shown by being plotted in increment of 1°. In each of part (a) of FIG. 8 to part (b) of FIG. 12, of points where a horizontal line H (FIG. 6) passing through the rotation center R of the peeling roller 32 crosses the surface of the third sleeve 35, the point on the second developing roller 31 side is taken as 0°, and angles are indicated clockwise (in a direction opposite to an arrow U direction (the rotational direction of the third sleeve 35) in FIG. 6).

Incidentally, the normal component Br of the magnetic flux density exactly refers to a normal direction component of the magnetic flux density B to the third sleeve 35. The normal component Br of the magnetic flux density of each magnet was measured using a magnetic field measuring device (“MS-9902” manufactured by F.W. BELL) under a condition such that a distance between a probe which is a member of the magnetic field measuring device and the surface of the third sleeve 35 was set to about 100 μm. Further, the tangential component Bθ of the magnetic flux density actually refers to a tangential direction component of the magnetic flux density B to the third sleeve 35. The tangential component Bθ of the magnetic flux density is acquired from the following formula (1) using a value of the normal component Br of the magnetic flux density.

$${B}_{θ} = - \frac{\partial {A}_{z} ( r , θ )}{\partial γ} ( {A}_{z} ( R , θ ) = {\int }_{0}^{θ} {RB}_{γ} d θ ) \qquad ( 1 )$$

Further, in a table 1 below, numerical values of an absolute value |Br|, a half-value width, and a peak angle of |Br| of a normal component of magnetic flux density of each of the feeding pole 304 and the peeling pole 305 of the third magnet 38, and an inter-pole angle between the feeding pole 304 and the peeling pole 305 are shown.

TABLE 1

| | FEEDING POLE 304*1 | | | PEELING POLE 305*2 | | | |
|---|---|---|---|---|---|---|---|
| | \|BR\| | HVW | BPA | \|Br\| | HVW | BPA | IPA*3 |
| | [Gauss] | [deg] | [deg] | [Gauss] | [deg] | [deg] | [deg] |
| COMP. | 650.7 | 22.3 | 308 | 295.4 | 27.4 | 271 | 37 |
| EX. 1 | | | | | | | |
| EMB. 1 | 650.7 | 29.8 | 280 | 295.4 | 27.4 | 244 | 36 |
| EMB. 2 | 650.7 | 30.8 | 294 | 295.4 | 27.4 | 244 | 50 |
| EMB. 3 | 650.7 | 21.8 | 308 | 295.4 | 33.7 | 271 | 37 |
| EMB. 4 | 650.7 | 37.4 | 308 | 295.4 | 28.1 | 251 | 57 |

*1, *2: “HVW” is the half-value width. “BPA” is the |Br| peak angle.
*3: “IPA” is the inter-pole angle.

Here, the half-value width is a width of a portion, respectively by angle, where the normal component Br of the magnetic flux density of each of magnetic poles becomes half at a peak value. In order to distinguish the half-value width from a half width at half maximum, the half-value width is also referred to as a full width at half maximum in some cases, but herein, the half-value width refers to the full width at half maximum. Further, the |Br| peak angle (angle of a position (peak position) where |Br| becomes a maximum value) is represented as an angle shown in a manner such that of points where the horizontal line H passing through the rotation center of the peeling roller 32 crosses the surface of the third sleeve 35, the point on the second developing roller 31 side is taken as 0° and the angle increases clockwise in FIG. 6.

Further, the inter-pole angle is an angle between peak positions of magnetic poles adjacent to each other, and is an angle between a peak position of the feeding pole 304 and a peak position of the peeling pole 305 in the table 1. That is, the interpole angle is an angle formed by a line connecting a position where an absolute value |Br| of the normal component of the magnetic flux density of the feeding pole 304 becomes maximum on the third sleeve 35 and the rotation center R of the third sleeve 35, and a line connecting a position where a position where an absolute value |Br| of the normal component of the magnetic flux density of the peeling pole 305 becomes maximum on the third sleeve 35 and the rotation center R of the third sleeve 35. Incidentally, the third magnets 38 of the peeling rollers 32 in the comparison example 1 and the embodiments 1 to 4 have the same constitutions (for example, the number of magnetic poles and an arrangement order of the magnetic poles) other than the distributions of the magnetic flux density.

### Comparison Example 1

A magnetic flux density distribution of the peeling roller 32 in the comparison example 1 shown in part (a) of FIG. 8 includes an inter-pole portion of the feeding pole 304 and the peeling pole 305 between from the free end position P1 of the guiding member 45 to the closest position P2 between the guiding member 45 and the peeling roller 32. In the inter-pole portion, the magnetic brush falls down until the angle Θ of the magnetic brush becomes approximately 0°, and therefore, as shown in part (b) of FIG. 7, the angle Θ of the magnetic brush on the peeling roller 32 in the comparison example 1 becomes 41° at the maximum, so that there remain concerns about collection of the toner, by the magnetic brush, deposited on the guiding member 45 due to scattering.

### Embodiment 1

On the other hand, a magnetic flux density distribution of the peeling roller 32 in the embodiment 1 shown in part (a) of FIG. 9 includes a peak of the normal component Br of the magnetic flux density of the feeding pole 304 in the closest position P2 between the guiding member 45 and the peeling roller 32. At the peak of the normal component Br, the angle Θ of the magnetic brush rises easiest, and as shown in part (b) of FIG. 9, the angle Θ of the magnetic brush on the peeling roller 32 in the embodiment 1 becomes −49.7° in the free end position P1 of the guiding member 45 (i.e., intersection point P1′ on the outer peripheral surface of the third sleeve 35), so that the magnetic brush collides against the toner deposited on the guiding member 45 in a state in which the free end of the magnetic brush is inclined in a direction opposite to the feeding direction, and therefore, the toner can be collected without disturbing the magnetic brush.

In order to cause the magnetic brush to enter the free end position P1 of the guiding member 45 without disturbing the magnetic brush, as described above, in the free end position P1, the angle Θ of the magnetic brush may preferably satisfy Θ≥−75°, more preferably satisfy Θ≥−60°, further preferably satisfy Θ≥−50°. Such a constitution is preferred. The angle Θ of the magnetic brush in the free end position P1 in the embodiment 1 satisfies such requirements.

Description of the embodiment 1 will be continued. After the magnetic brush enters the free end position P1 of the guiding member 45 without being disturbed, the angle Θ of the magnetic brush gradually rises from the free end position P1 of the guiding member 45 toward the closest position P2 of the guiding member 45 to the peeling roller 32, so that the angle Θ becomes 75.10 when the magnetic brush passes through the closest position P2 (i.e., the closest position P2′ on the outer peripheral surface of the third sleeve 35). By this, the angle Θ of the magnetic brush in the closest position P2 is in a state (the above-described state of part (b) of FIG. 7) in which the fee end of the magnetic brush is directed toward a side downstream of the toner deposited on the guiding member 45 with respect to the feeding direction of the developer by the third sleeve 35. For this reason, as described above, the toner deposited on the guiding member 45 can be collected by the magnetic brush so as to be scraped off the toner, so that a toner collecting property by the magnetic brush can be enhanced.

Therefore, in the constitution of the embodiment 1, the magnetic brush can be caused to enter the free end position P1 of the guiding member 45 without being disturbed, and the angle Θ of the magnetic brush is constituted so as to satisfy arctan (Br/Bθ)≥45° or arctan (Br/Bθ)≤−45° over a whole area of a region from the free end position P1 of the guiding member 45 to the closest position P2 of the guiding member 45 to the peeling roller 32 (i.e., a region from the intersection point P1′ on the outer peripheral surface of the third sleeve 35 to the closest position P2′ with respect to the rotational direction of the third sleeve 35). For this reason, the collecting property of the toner by the magnetic brush can be enhanced.

Further, in the closest position P2, the gap between the guiding member 45 and the peeling roller 32 becomes narrowest in a range from the free end position P1 of the guiding member 45 to the closest position P2 of the guiding member 45 to the peeling roller 32, and therefore, there is a liability that clogging occurs by the deposited toner. However, by employing the constitution of the embodiment 1, the magnetic brush is capable of passing through the closest position P2 at an angle at which the toner collecting property by the magnetic brush is high, and therefore, the deposited toner can be collected by the magnetic brush without causing the clogging of the toner in the closest position P2.

As described above, as in the embodiment 1, the peak position of the normal component Br of the magnetic flux density of the feeding pole 304 is positioned in the closest position P2 between the peeling roller 32 and the guiding member 45 or in the neighborhood of the closest position P2, so that an effect as described above can be obtained. For example, with respect to the rotational direction of the third sleeve 35, the peak position of the normal component Br of the magnetic flux density of the feeding pole 304 may preferably fall within a range of ±10° of the closest position P2, i.e., in the case where the closest position P2 is 0°, the peak position of the normal component Br may preferably be in a range within 10° toward an upstream side or a range within 10° toward a downstream side.

### Embodiment 2

A magnetic flux density distribution of the peeling roller 32 in the embodiment 2 shown in part (a) of FIG. 10 includes a peak of the normal component Br of the magnetic flux density of the feeding pole 304 in the free end position P1 of the guiding member 45. At the peak of the normal component Br, the angle Θ of the magnetic brush rises easiest, and s shown in part (b) of FIG. 10, the angle Θ of the magnetic brush on the peeling roller 32 in the embodiment 2 becomes −89.2° in the free end position P1 of the guiding member 45 (i.e., intersection point P1′ on the outer peripheral surface of the third sleeve 35).

Then, the magnetic brush becomes from a state in which the angle Θ of the magnetic brush relative to the toner deposited on the guiding member 45 is raised substantially vertically to a state in which the free end of the magnetic brush is inclined toward the downstream side of the developer feeding direction by the third sleeve to the closest position P2 between the peeling roller 32 and the guiding member 45. For this reason, from the free end position P1 of the guiding member 45, the toner deposited on the guiding member 45 can be collected by the magnetic brush so as to be scraped off the toner, so that the toner collecting property on the guiding member 45 by the magnetic brush can be enhanced.

In order to reliably suppress scattering of the developer due to disturbance of the magnetic brush magnetic brush passes through the free end position P1 of the guiding member 45, it is preferable that the angle Θ of the magnetic brush is changed in accordance with the gap between the peeling roller 32 and the guiding member 45 in the free end position P1 of the guiding member 45. Specifically, when the gap between the peeling roller 32 and the guiding member 45 is 0.8 mm or more and less than 1.2 mm, the angle Θ of the magnetic brush may preferably satisfy 45°≤arctan (Br/Bθ)≤60°, and when the gap is 1.2 mm or more, arctan (Br/B)≥60° may preferably be satisfied. By this, the free end of the magnetic brush does not collide against the guiding member 45 in the free end position P1 of the guiding member 45 or can be caused to moderately collide against the guiding member 45 in the free end position P1. Then, a constitution in which when the scattered toner is deposited on the guiding member 45, the magnetic brush contacts the toner on the guiding member 45 without sealing the gap between the peeling roller 32 and the guiding member 45.

As described above, as in the embodiment 2, the peak position of the normal component Br of the magnetic flux density of the feeding pole 304 is positioned in the free end position 1 or in the neighborhood of the free end position P1, so that an effect as described above can be obtained. For example, with respect to the rotational direction of the third sleeve 35, the peak position of the normal component Br of the magnetic flux density of the feeding pole 304 may preferably fall within a range of ±10° of the free end position P1, i.e., in the case where the free end position P1 is 0°, the peak position of the normal component Br may preferably be in a range within 10° toward an upstream side or a range within 10° toward a downstream side.

### Embodiment 3

A magnetic flux density distribution of the peeling roller 32 in the embodiment 3 shown in part (a) of FIG. 11 is such that compared with the comparison example 1, the embodiment 1, and the embodiment 2, the half-value width of the peeling pole 305 is made large to a position upstream of the closest position P2 between the guiding member 45 and the peeling roller 32 with respect to the feeding direction of the third sleeve 35. Specifically, the half-value width of the peeling pole 305 may preferably include a range of 29° or more on a side upstream of the closest position P2 with respect to the rotational direction of the third sleeve 35. Further, the half-value width of the peeling pole 305 may more preferably include a range of 31° or more on the side upstream of the closest position P2 with respect to the rotational direction of the third sleeve 35. Further, the half-value width of the peeling pole 305 may further preferably include a range of 33° or more on the side upstream of the closest position P2 with respect to the rotational direction of the third sleeve 35.

In the embodiment 3, even when the peak of the normal component Br of the magnetic flux density of the feeding pole 304 is not disposed between from the free end position P1 of the guiding member 45 to the closest position P2 of the guiding member 45 to the peeling roller 32 (i.e., between from the intersection point P1′ on the outer peripheral surface of the third sleeve 35 to the closest position P2′ with respect to the rotational direction of the third sleeve 35), the normal component Br of the magnetic flux density of the peeling pole 305 in the closest position P2 is strengthened by increasing the half-value width of the magnetic flux density of the peeling pole 305, so that the angle Θ of the magnetic brush is caused to rise readily. As shown in part (b) of FIG. 11, the angle Θ of the magnetic brush on the peeling roller 32 in the embodiment 3 becomes 56.7° in the closest position P2 between the peeling roller 32 and the guiding member 45 (i.e., in the closest position P2′ on the outer peripheral surface of the third sleeve 35). Further, the magnetic brush is in a state in which the free end of the magnetic brush relative to the toner deposited on the guiding member 45 is inclined so as to be directed toward a downstream side of the feeding direction of the developer by the third sleeve 35. For this reason, the toner deposited on the guiding member 45 can be collected by the guiding member 45 so as to be scraped off.

### Embodiment 4

A magnetic flux density distribution of the peeling roller 32 in the embodiment 4 shown in part (a) of FIG. 12 is such that compared with the comparison example 1, the embodiments 1 to 3, the inter-pole angle between the feeding pole 304 and the peeling pole 305 is made large. When the inter-pole angle is narrowed, a length of the magnetic brush extends, but the magnetic brush falls down soon, and therefore, the inter-pole angle may preferably be made large.

In the embodiment 4, even when the peak of the normal component Br of the magnetic flux density of the feeding pole 304 is not disposed between from the free end position P1 of the guiding member 45 to the closest position P2 of the guiding member 45 to the peeling roller 32 (i.e., between from the intersection point P1′ on the outer peripheral surface of the third sleeve 35 to the closest position P2′ with respect to the rotational direction of the third sleeve 35), the inter-pole angle between the feeding pole 304 and the peeling pole 305 is made large, and thus a width of an effective angle between the normal component Br and the tangential component Bθ of the magnetic flux density of the feeding pole 304 is widened, so that the angle Θ of the magnetic brush is made hard to fall down. As shown in part (b) of FIG. 12, the angle Θ of the magnetic brush on the peeling roller 32 in the embodiment 4 becomes 67.8° in the free end position P1 of the guiding member 45 (i.e., in the intersection point P1′ on the outer peripheral surface of the third sleeve 35). Further, the magnetic brush is in a state in which the free end of the magnetic brush relative to the toner deposited on the guiding member 45 is inclined so as to be directed toward a downstream side of the feeding direction of the developer by the third sleeve 35. For this reason, the toner deposited on the guiding member 45 can be collected by the guiding member 45 so as to be scraped off.

In order to make the magnetic brush hard to fall down, the interpole angle between the feeding pole 304 and the peeling pole 305 may preferably be made 20° or more, more preferably be made 30° or more, further preferably be made 40° or more. However, when the inter-pole angle is made excessively large, a developer holding force lowers, so that there is a liability that the developer is scattered, and therefore, the inter-pole angle may preferably be 90° or less, more preferably 75° or less, further preferably be 60° or less.

### OTHER EMBODIMENTS

The present disclosure is not limited to the constitution of the above-described embodiment. For example, the image forming apparatus 100 is not limited to the MFP, but may also be a copying machine, a printer, or a facsimile machine. Further, the constitutions of the developer supplying screw 42, the developer stirring screw 43, and the developer collecting screw 44 are not particularly limited when the constitutions can convey the developer, and for example, it is possible to apply a helical blade, a paddle-like blade.

Further, in the above-described embodiments, the case where with respect to the rotational direction of the photosensitive drum 28Y, the first developing roller 30 is disposed on an upstream side and the second developing roller 31 is disposed on a downstream side was described, but a similar effect is obtained even in the case where the second developing roller 31 is disposed on the upstream side and the first developing roller 30 is disposed on the downstream side.

Further, in the above-described embodiments, the case where as the developing roller for developing the electrostatic latent image on the photosensitive drum, two developing rollers consisting of the first developing roller 30 and the second developing roller 31 was described, but even in a constitution in which a single developing roller is disposed, the present disclosure is applicable. Further, in the above-described embodiments, the case where the five magnetic poles (the number of magnetic poles: 5) of the third magnet 38 included in the peeling roller 32 are disposed was described, but even in a constitution in which two magnetic poles are added to between the receiving pole 303 and the feeding pole 304, and the number of the magnetic poles is made 7, the present disclosure is applicable. That is, the receiving pole 303 and the feeding pole 304 are not necessarily required to be adjacent to each other.

According to the present disclosure, it is possible to suppress that an image defect occurs.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application Nos. 2024-165004 filed on Sep. 24, 2024, and 2025-139265 filed on Aug. 22, 2025, which are hereby incorporated by reference herein in their entirety.

What is claimed is:

1. A developing device comprising:
a first chamber configured to accommodate a developer including toner and a carrier;
a first feeding screw provided in the first chamber and configured to feed the developer accommodated in the first chamber;
a second chamber partitioned from the first chamber by a partition wall;
a second feeding screw provided in the second chamber and configured to feed the developer accommodated in the second chamber;
a first rotatable developing member to which the developer is supplied, the first rotatable developing member carrying and feeding the developer to a developing position where an electrostatic latent image formed on an image bearing member is developed;
a first magnet provided non-rotatably and stationarily inside the first rotatable developing member, the first magnet including a first magnetic pole provided opposed to the image bearing member in the developing position, a second magnetic pole provided downstream of the first magnetic pole with respect to a rotational direction of the first rotatable developing member, and a third magnetic pole provided downstream of the second magnetic pole and adjacent to the second magnetic pole, with respect to the rotational direction of the first rotatable developing member, and having the same magnetic polarity as that of the second magnetic pole;
a second rotatable member provided opposed to the first rotatable developing member and to which the developer is delivered from the first rotatable developing member by a magnetic field generated by the first magnet, the second rotatable member carrying and feeding the developer for collecting, in the second chamber, the developer after the electrostatic latent image is developed;
a second magnet provided non-rotatably and stationarily inside the second rotatable member, the second magnet including a fourth magnetic pole having a magnetic polarity different from that of the second magnetic pole, a fifth magnetic pole provided downstream of the fourth magnetic pole with respect to a rotational direction of the second rotatable member, a sixth magnetic pole provided downstream of the fifth magnetic pole and adjacent to the fifth magnetic pole, with respect to the rotational direction of the second rotatable member, and having a magnetic polarity different from that of the fifth magnetic pole, and a seventh magnetic pole provided downstream of the sixth magnetic pole and adjacent to the sixth magnetic pole, with respect to the rotational direction of the second rotatable member, and having the same magnetic polarity as that of the sixth magnetic pole; and
a guiding portion provided opposed to the second rotatable member and configured to guide the developer to the second feeding screw,
wherein the first rotatable developing member and the second rotatable member rotate in the same direction in mutually opposing positions thereof,
wherein the developer after the electrostatic latent image is developed is delivered from the first rotatable developing member to the second rotatable member by a magnetic field generated between the second magnetic pole and the fourth magnetic pole; and
wherein in a case where
a normal component of magnetic flux density in an arbitrary point on an outer peripheral surface of the second rotatable member opposing an inclined surface of the guiding portion is Br,
a tangential component of the magnetic flux density in the arbitrary point is Bθ, and
an angle Θ of a magnetic brush in the arbitrary point is arctan (Br/Bθ),
with respect to the rotational direction of the second rotatable member, there is a portion where an absolute value of the angle Θ of the magnetic brush is 45° or more in a range from an intersection point, on the outer peripheral surface of the second rotatable member, which is a point where a rectilinear line passing through an end portion of the guiding portion on a side opposite from the second feeding screw and a rotation center of the second rotatable member crosses the outer peripheral surface of the second rotatable member, to a closest point, on the outer peripheral surface of the second rotatable member, which is a point where the outer peripheral surface of the second rotatable member is closest to the guiding portion.

2. The developing device according to claim 1, wherein with respect to the rotational direction of the second rotatable member, in the range from the intersection point to the closest point, there is a portion where the absolute value of the angle Θ of the magnetic brush is 50° or more.

3. The developing device according to claim 1, wherein with respect to the rotational direction of the second rotatable member, in the range from the intersection point to the closest point, there is a portion where the absolute value of the angle Θ of the magnetic brush is 60° or more.

4. The developing device according to claim 1, wherein with respect to the rotational direction of the second rotatable member, the absolute value of the angle Θ of the magnetic brush is 45° or more over a whole area of the range from the intersection point to the closest point.

5. The developing device according to claim 1, wherein the absolute value of the angle Θ of the magnetic brush in the closest point is 45° or more.

6. The developing device according to claim 1, wherein the absolute value of the angle Θ of the magnetic brush in the closest point is 50° or more.

7. The developing device according to claim 1, wherein the absolute value of the angle Θ of the magnetic brush in the closest point is 60° or more.

8. The developing device according to claim 1, wherein in a case where
the angle Θ of the magnetic brush when the magnetic brush in the arbitrary point is inclined so that the magnetic brush falls in the rotational direction of the second rotatable member with respect to a virtual line passing through the arbitrary point and the rotation center of the second rotatable member is positive, and
the angle Θ of the magnetic brush when the magnetic brush in the arbitrary point is inclined so that the magnetic brush falls in a direction opposite to the rotational direction of the second rotatable member with respect to the virtual line passing through the arbitrary point and the rotation center of the second rotatable member is negative,
the angle Θ of the magnetic brush in the intersection point satisfies Θ≥−75°.

9. The developing device according to claim 1, wherein in a case where
the angle Θ of the magnetic brush when the magnetic brush in the arbitrary point is inclined so that the magnetic brush falls in the rotational direction of the second rotatable member with respect to a virtual line passing through the arbitrary point and the rotation center of the second rotatable member is positive, and
the angle Θ of the magnetic brush when the magnetic brush in the arbitrary point is inclined so that the magnetic brush falls in a direction opposite to the rotational direction of the second rotatable member with respect to the virtual line passing through the arbitrary point and the rotation center of the second rotatable member is negative,
the angle Θ of the magnetic brush in the intersection point satisfies Θ≥−60°.

10. The developing device according to claim 1, wherein in a case where
the angle Θ of the magnetic brush when the magnetic brush in the arbitrary point is inclined so that the magnetic brush falls in the rotational direction of the second rotatable member with respect to a virtual line passing through the arbitrary point and the rotation center of the second rotatable member is positive, and
the angle Θ of the magnetic brush when the magnetic brush in the arbitrary point is inclined so that the magnetic brush falls in a direction opposite to the rotational direction of the second rotatable member with respect to the virtual line passing through the arbitrary point and the rotation center of the second rotatable member is negative,
the angle Θ of the magnetic brush in the intersection point satisfies Θ≥−50°.

11. The developing device according to claim 1, wherein a closest distance between the second rotatable member and the guiding portion is 0.8 mm or more and 5 mm or less.

12. The developing device according to claim 1, wherein a closest distance between the second rotatable member and the guiding portion is 1.2 mm or more and 4 mm or less.

13. The developing device according to claim 1, wherein a closest distance between the second rotatable member and the guiding portion is 1.5 mm or more and 3 mm or less.

14. The developing device according to claim 1, wherein with respect to the rotational direction of the second rotatable member, in the range from the intersection point to the closest point, the magnetic brush contacts the guiding portion in the portion where the absolute value of the angle Θ of the magnetic brush is 45θ or more.

15. The developing device according to claim 1, wherein the end portion of the guiding portion on the side opposite from the second feeding screw is positioned above a rotation center of the first rotatable developing member in a vertical direction.

16. The developing device according to claim 1, wherein with respect to the rotational direction of the second rotatable member, an angle from a point on the outer peripheral surface of the second rotatable member where an absolute value of a normal component Br of magnetic flux density of the fifth magnetic pole becomes maximum to a point of the outer peripheral surface of the second rotatable member where an absolute value of a normal component Br of magnetic flux density of the sixth magnetic pole becomes maximum is 20° or more.

17. The developing device according to claim 1, wherein with respect to the rotational direction of the second rotatable member, an angle from a point on the outer peripheral surface of the second rotatable member where an absolute value of a normal component Br of magnetic flux density of the fifth magnetic pole becomes maximum to a point of the outer peripheral surface of the second rotatable member where an absolute value of a normal component Br of magnetic flux density of the sixth magnetic pole becomes maximum is 30° or more.

18. The developing device according to claim 1, wherein with respect to the rotational direction of the second rotatable member, an angle from a point on the outer peripheral surface of the second rotatable member where an absolute value of a normal component Br of magnetic flux density of the fifth magnetic pole becomes maximum to a point of the outer peripheral surface of the second rotatable member where an absolute value of a normal component Br of magnetic flux density of the sixth magnetic pole becomes maximum is 40° or more.

19. The developing device according to claim 1, wherein a half-value width of a normal component Br of magnetic flux density of the sixth magnetic pole includes a range of 29° or more on a side upstream of the closest point with respect to the rotational direction of the second rotatable member.

20. The developing device according to claim 1, wherein a half-value width of a normal component Br of magnetic flux density of the sixth magnetic pole includes a range of 31° or more on a side upstream of the closest point with respect to the rotational direction of the second rotatable member.

21. The developing device according to claim 1, wherein a half-value width of a normal component Br of magnetic flux density of the sixth magnetic pole includes a range of 33° or more on a side upstream of the closest point with respect to the rotational direction of the second rotatable member.

22. The developing device according to claim 1, wherein the rotation center of the second rotatable member is positioned above a rotation center of the first rotatable developing member in a vertical direction.

23. The developing device according to claim 1, wherein a rotation center of the second feeding screw is positioned above a rotation center of the first feeding screw in a vertical direction.

24. The developing device according to claim 1, further comprising:
a third rotatable member provided opposed to the first rotatable developing member and to which the developer accommodated in the first chamber is supplied, the third rotatable member carries and feeds the developer for developing the electrostatic latent image; and
a third magnet provided non-rotatably and stationarily inside the third rotatable member,
wherein the first rotatable developing member and the third rotatable member rotate in opposite directions in mutually opposing positions thereof, and
wherein to the first rotatable developing member, the developer is delivered from the third rotatable member by a magnetic field generated by the third magnet.
